(19) United States
(12) Patent Application Publication
(10) Pub. No.: US 2002/0118804 A1
(43) Pub. Date: Aug. 29, 2002

(54) Caller-identification phone without ringer

(76) Inventors: Elisa Carroll, East Islip, NY (US); Russell Carroll, East Islip, NY (US)

Correspondence Address: ALFRED M. WALKER, 225 OLD COUNTRY ROAD, MELVILLE, NY, 11747-2712, US

(21) Appl. No.: 10/045,666

(22) Filed: Oct. 22, 2001

Related U.S. Application Data
(60) Provisional application No. 60/266,936, filed on Feb. 8, 2001.
(60) Provisional application No. 60/243,355, filed on Oct. 26, 2000.

(51) Int. Cl. H04M 1/64; H04M 1/00

(52) U.S. Cl. 379/88.19; 379/88.01; 379/373.01

(57) ABSTRACT

A telephone device includes a caller identification (Caller-I.D.) feature, but without a ringing type annunciator, and which requires minimal set-up by a consumer. The caller identification system selects the preferred language of the user which has a natural sounding synthesized voice. It can turn off all audio annunciation of a received call and ignores calls where no caller-identification information about the calling party is available. The caller identification device which is adaptable to table-top or wall-mount phones as well as to cordless phones and cellular phones.

### FIELD OF THE INVENTION

The present invention relates to caller identification telephone devices, which dispense with audible ringers.

### BACKGROUND OF THE INVENTION

Among related patents include U.S. Pat. No. 5,265,145 of Lim for an alphanumeric caller identification telephone that has both a visually displayable alphanumeric telephone identification system and an audible output that speaks the name of the caller.

U.S. Pat. No. 5,850,435 of Devillier describes a caller identification system and U.S. Pat. No. U.S. Pat. No. 5,646,979 of Knuth passes caller identification information through a voice synthesizer for announcing a telephone number.

U.S. Pat. Nos. 5,526,406 and 6,038,443, both of Luneau, describe a vocalized caller identification system that is used on standard household telephone sets, and which does not require a momentary tape recording of the caller's voice, as in standard collect type calls.

U.S. Pat. No. 5,533,102 of Robinson describes a caller identification device hooked up to a personal computer that can audially answer the call. U.S. Pat. No. 5,303,301 of Takahata describes a caller identification telephone system and U.S. Pat. No. 5,561,053 of Mitchell describes a call screening device that blocks unwanted calls, but which requires the caller to record his or her voice first.

However, many of these prior art devices only supplement a conventional ringer of a telephone with a caller identification output, rather than dispense with the ringer if the user so chooses.

Furthermore, some of these prior art devices are complicated computerized networks.

### OBJECTS OF THE INVENTION

It is therefore an object of the present invention to provide a telephone with caller-identification feature, but without a ringing type annunciator.

It is another object of the present invention to provide a telephone with caller-identification feature that requires minimal set-up by a consumer.

It is also an object of the present invention to provide a caller identification system, which selects the preferred language of the user.

It is yet another object of the present invention to provide a caller identification device, which turns off all audio annunciation of a received call.

It is a further object of the present invention to provide a caller identification device which ignores calls where no caller-identification information about the calling party is available.

It is yet another further object of the present invention to provide a caller ID device which is adaptable to table-top or wall-mount phones as well as to cordless phones and cellular phones.

It is also an object of the present invention to provide a voice announced caller identification device which has a natural sounding synthesized voice.

It is another object of the present invention to improve over the disadvantages of the prior art.

### SUMMARY OF THE INVENTION

The present invention includes a telephone with caller identification feature, but without a ringing type annunciator. Involving minimal user set-up, only three mode switches must be set for proper use. The present invention removes the ringer and adds a voice synthesis sub-system to a built-in caller identification feature. The audible output provides the number of the incoming telephone call and/or the identity of the incoming caller. If the incoming call blocks caller identification at the caller sending end, the device can announce “no name” or “anonymous” if that is the case. Alternatively, the device can disable these anonymous incoming calls so that no audible sound is heard by the user.

The first switch selects the preferred language among a few choices offered by the manufacturer.

A second switch can turn off all audio annunciation of a received call.

A third switch can be used to ignore calls where no caller-information about the calling party is available.

A fourth switch, which is the “on/off” switch, turns on the device and disables the conventional ringer of the telephone.

If a name is available through caller-identification, it is announced verbally. If only a number is available, it is recited verbally. If no information is available, the system will announce “anonymous” in the language of choice.

The voice synthesis subsystem speaks audibly perceptible numbers and words formed by the identity of the incoming calls without the need for a memory with lists of specified callers.

This system is adaptable to table-top or wall-mount phones as well as to cordless phones and cellular phones.

In use, the caller-identification device announces an identity of a phone caller by routing a telephone ring signal to a microprocessor, which disables the ring signal and determines whether incoming caller line identifier signal information contains a caller's name and phone number. The processor determines whether the information corresponds with pre-programmed words, numbers and phonetic phrases stored in the microprocessor.

The device selects the words, numbers and phonetic phrases which corresponds with the incoming information and sends a digital signal which corresponds with the selected words, numbers and phonetic phrases. The device converts the digital signal to an analog signal and amplifies the analog signal before sending the amplified signal to a speaker.

The microprocessor includes a first switch that selects a language for the digital signal. A second switch selects whether the audio annunciation is on and a third switch selects whether to ignore calls which do not have a caller name or caller number, such as from a restricted number which does not disclose identification of an incoming caller. The fourth switch is the “on and off” switch which activates the device and disables the audible ringer of the telephone.

In determining whether the information corresponds with pre-programmed words, numbers and phonetic phrases, the device takes a first name from the information and compares the first name to the pre-programmed words and uses said phonetic phrases to construct pronunciation of the first name, if the first name is not one of said pre-programmed words. The device takes a second name from the information and compares the second name to the pre-programmed words and uses the phonetic phrases to construct pronunciation of the second name if the second name is not one of the pre-programmed words. For multiple common names, such as “John Smith”, this comparison can be repeated with other indicia, such as addresses or middle initials, as needed, until the device determines that the incoming caller information is anonymous, if no first name, no second name or other identifying information, and no phone number is within the information stored in the microprocessor.

The digital signal sends the first name if the first name is within the stored information, sends the second name if the second name is within the stored information and sends the retrieved phone number if the phone number is within the stored information to the audio speaker component to announce this information, in the absence of a ring.

The word “anonymous” is announced if no identified first name, no identified second name and no identified phone number is available. Optionally, the user can block these restricted access, anonymous calls, so that no audible annunciation of these calls is heard.

The device of the present invention requires no user set-up, such as entering lists of particular names and numbers of persons who usually call. It does not require pre-recording of the names and addresses of particular persons. Instead, its phonetic voice synthesis function announces names and/or numbers by synthesizing these names and numbers from a pre-set alphabetical and numerical portions of words and numbers.

### BRIEF DESCRIPTION OF THE DRAWINGS

The present invention can best be understood in conjunction with the accompanying drawings, in which:

FIG. 1 is a block diagram of the call-identification telephone device of this invention; and

FIG. 2 is a flow chart of an alternate embodiment for a hybrid voice synthesis system.

### DETAILED DESCRIPTION OF THE PRESENT INVENTION

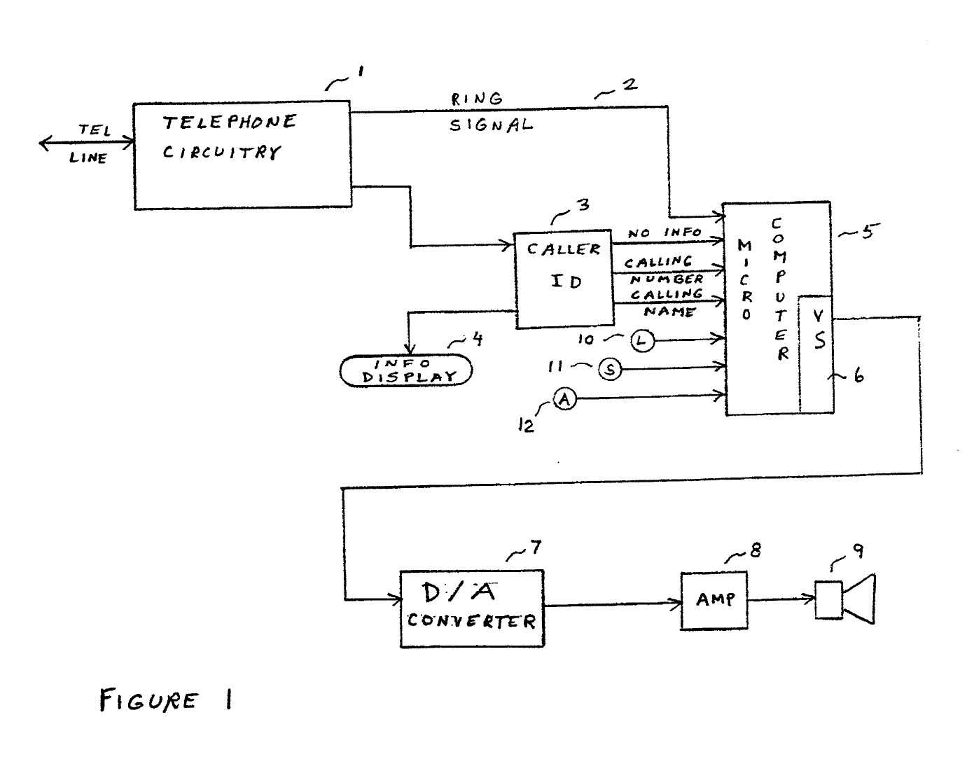

FIG. 1 is a block diagram showing the elements of this invention, which distinguish it from present telephones. The device can be built into a conventional telephone, such as a land wired, cordless or cellular telephone, or can be constructed in a separate unit connected by conventional telephone connector to a telephone.

The telephone circuitry 1 includes all functions to answer a call or to initiate a call, but it does not include the ringer function, which is disabled by the “on/off” switch of the device. Therefore, the ring signal 2 is not annunciated in an audibly perceptible sound. The ring signal 2 is routed to a micro computer. The Caller-Identification subsystem 3 sends information to display 4, which is usually implemented as a liquid crystal display. It also sends information such as “no info”, the calling number, and the calling party name to micro computer 5.

A large portion of computer 5 is devoted to the voice synthesis function 6. Once a digital stream of vocal information is formed, it is converted to an analog stream by the Digital to Analog (D/A) converter 7 and passed on to an audio amplifier 8 and further to loudspeaker 9 to alert the user of an incoming call.

Three customer set-up mode switches are also included as follows. Multi-position language switch 10 selects the language database to be used by micro computer 5. Two-position switch 11 determines if “no sound” is selected which essentially disables any sound annunciation of an incoming call. Two-position switch 12 will permit announcing the fact that an incoming call is “anonymous”, or in the alternate position, no announcement of this event type is made.

Although standard voice synthesis software can be used for the annunciator function whereby names are just input as letter streams, a hybrid system is used in the preferred embodiment. The advantage of this approach is more natural sounding number and first name annunciating.

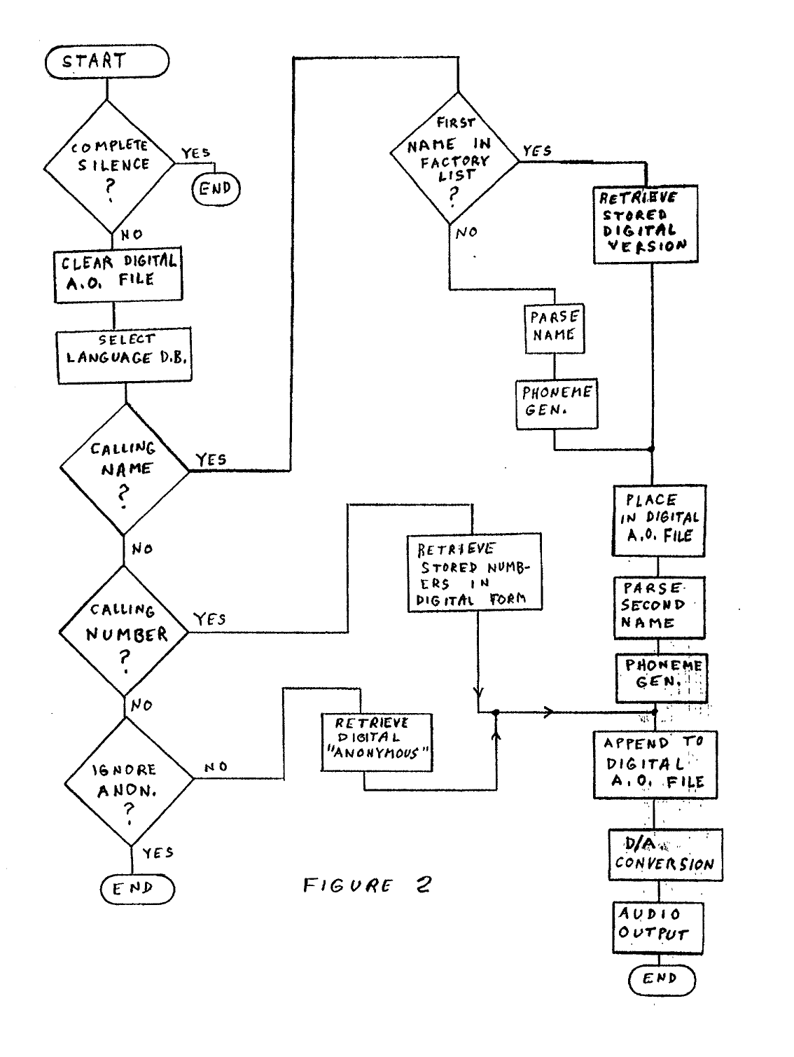

FIG. 2 is a flow chart of this hybrid system. In this system, number sounds, and sounds of common first names are stored as digital streams by digitizing actual speech at the factory.

Instead of going through the standard conversion of written-to-synthesized sound, these familiar items only would be presented in a less “machine stylized” and in a more natural form.

The flow chart of FIG. 2 starts with an interrogation of the “silence” function switch.

If annunciation is permitted, the audio output (a.o.) file is cleared. Then a language data base is selected according to the selector switch position.

If the calling name is available from Caller-ID, the system checks to see if the first name is in the factory provided list.

If it is in the list, the digital version is retrieved.

If the first name is not in the list, the normal synthesis function is performed by first parsing the name into syllables using language-dependent rules; then the phonemes are generated through language-dependent phonetic rules.

In either case, the digital form of the sound of the first name is placed in the a.o. file. Then the second name is parsed followed by phoneme generation.

The digital form of the second name is appended to the first name in the a.o. file. The a.o. file contents are then passed through a digital to analog converter and appropriate filters in the audio output block are used prior to amplification and emergence as sound via a loudspeaker.

If no calling party name information is available, the digital sound images of the calling party number in the selected language are retrieved and sent to the a.o. file and output as a form of announcing that a call has been received.

If neither name nor number are available from Caller-ID, the “ignore anonymous” mode switch is interrogated.

If announcement is permitted, the digital form of the word “anonymous” in the selected language is retrieved, placed in the a.o. file and output as a form of announcement that a call has been received.

It is further noted that other modifications may be made to the present invention, without departing from the scope of the invention, as noted in the appended claims.

We claim:

1. A method of announcing an identity of a phone caller comprising:
routing a telephone ring signal of an incoming telephone call to a microprocessor;
disabling an audible output of said telephone ring signal from being audibly perceptible;
determining whether incoming caller line identifier signal information contains a caller's name and phone number;
determining whether said information corresponds with pre-programmed words, numbers and phonetic phrases stored in said microprocessor;
selecting said words, numbers and phonetic phrases which correspond with said information;
sending a digital signal which corresponds with said selected words, numbers and phonetic phrases;
converting said digital signal to an analog signal; amplifying said analog signal; and,
sending said amplified signal to a speaker.

2. The method of announcing an identity of a phone caller of claim 1 wherein said first microprocessor further comprises
a first switch selecting a language for said digital signal;
a second switch selecting whether said audio annunciation is on and disabling all sound annunciation of said incoming telephone call;
a third switch selecting whether to ignore calls which do not have said caller name or caller number; and,
a fourth switch controlling said disabling of said audible output of said telephone ring signal from being audibly perceptible.

3. The method of announcing an identity of a phone caller of claim 1 wherein said determination whether said information corresponds with pre-programmed words, numbers and phonetic phrases further comprises:
taking a first name from said information and comparing said first name to said pre-programmed words and using said phonetic phrases to construct pronunciation of said first name if said first name is not one of said pre-programmed words;
taking a second name from said information and comparing said second name to said pre-programmed words and using said phonetic phrases to construct pronunciation of said second name if said second name is not one of said pre-programmed words; and
identifying said information as anonymous if no said first name, no said second name and no said phone number is within said information.

4. The method of announcing an identity of a phone caller of claim 1 wherein sending of said digital signal further comprises:
sending said first name if said first name is within said information;
sending said second name if said second name is within said information;
sending said phone number if said phone number is within said information;
sending said anonymous identifier if no said first name, no said second name and no said phone number is available.

5. A caller-identification telephone device, which dispenses with an audible ringer associated therewith comprising:
an on/off switch which disables an audible ringer of a telephone;
a processor processing incoming telephone calls into a perceptible display;
said processor having a converter converting said perceptible display of an incoming telephone call identification to an audible sound announcing an identity of an incoming telephone call;
a first further switch selecting a predetermined language announcing said audible identity of the incoming telephone call;
a second further switch responsive to turning off audio annunciation of the incoming call; and,
a third further switch bypassing and terminating an incoming telephone call where no caller-identification information identity of the incoming telephone call is available; and,
wherein further, if the identity of said incoming telephone call is available through said caller identification device, said identity is announced verbally by a loudspeaker in an audibly perceptible sound.

6. The caller-identification telephone device as in claim 5, wherein if no information is available in the said processor identifying said incoming telephone call, said speaker announces audibly that said incoming call is anonymous.

7. The call identification telephone device as in claim 5, wherein said processor includes a connector connecting said caller identification device to a land line wired telephone.

8. The call identification telephone device as in claim 5, wherein said processor includes a connector connecting said caller identification device to a cordless telephone.

9. The caller identification telephone device as in claim 5, wherein said processor includes a connector connecting said caller identification device to a cellular telephone.

10. The caller identification telephone device as in claim 6 further comprising telephone circuitry including functions to answer said incoming telephone call and to initiate said incoming telephone call, and said telephone circuitry including a ringer bypass function communicating with said switch disabling said audible ringer of said telephone;
wherein said incoming ring signal is not annunciated and is routed to said processor, said processor sending said identification information into a digital data stream; and,
a voice synthesizer converting said digital data stream into an analog data stream by a digital to analog converter, said analog data stream being passed on to an audio amplifier and to said loudspeaker, said loudspeaker emitting said audibly perceptible sound and alerting the user of said incoming telephone call.

11. The caller identification telephone device as in claim 10, wherein said first further switch is a multi-position language switch 1 selecting said predetermined language.

12. The call identification telephone device as in claim 10, wherein said second further switch determines if no sound is selected, thereby disabling any audible sound annunciation of an incoming call.

13. The caller identification telephone device as in claim 10, wherein said third further switch is silent.

14. The caller identification telephone device as in claim 10, wherein said voice synthesizer announces names as predetermined letter streams.

15. The caller identification telephone device as in claim 10, wherein said voice synthesizer produces natural sounding number and name annunciating sounds.

16. The caller identification telephone device as in claim 10, wherein predetermined number sounds, and sounds of common names are stored as digital streams by digitizing actual speech.

17. The caller identification telephone device as in claim 16, wherein said digitized actual speech is performed by first parsing a predetermined name into syllables using language-dependent rules, and then generating phonemes through language-dependent phonetic rules in an audio output file in said processor, wherein if said digital form of the sound of a first predetermined name is placed in said audio output file, a second predetermined name is parsed followed by phoneme generation, wherein further said digital form of said second predetermined name is appended to said first predetermined name in said audio output file, said audio output file passing contents therein through a digital to analog converter and a filter in said audio output prior to amplification and emergence as sound via said loudspeaker.

18. The caller identification telephone device as in claim 17, wherein if no calling party name information is available, digital sound images of said calling party number in said selected language are retrieved and sent to said audio output file and are output as an audible perceptible form of announcing that a call has been received.

19. The caller identification telephone device as in claim 17, wherein if announcement is permitted, said digital stream is the word “anonymous” in said selected language, and announced that an anonymous call has been received.
